(19) United States
(12) Patent Application Publication
(10) Pub. No.: US 2014/0372766 A1
(43) Pub. Date: Dec. 18, 2014

(54) AUTOMATED DOCUMENT NOTARIZATION

(71) Applicant: Pitney Bowes Inc., Stamford, CT (US)

(72) Inventor: Frederick W. Ryan, JR., Oxford, CT (US)

(21) Appl. No.: 13/917,676

(22) Filed: Jun. 14, 2013

(51) Int. Cl. H04L 9/32

(52) U.S. Cl. CPC H04L 9/3247
USPC 713/178

(57) ABSTRACT

An automated notarization device includes a scanner, printer, hardware security module and camera. The hardware security module includes a secure processor and secure storage for data records and cryptographic keys, along with a secure real time clock. A person desiring to have a document notarized presents the document to the device, presents identification to the device, and has his/her picture and or video taken. Each of these items is stored in a data record, which is then displayed to the person for approval. Upon approval, the data record is provided to the hardware security module, which adds a timestamp to the data record and then digitally signs the data record. The resulting signed data record ties together the original document, and identification of the person, and a timestamp. Changes to any of these data elements can be detected by verifying the digital signature.

### FIELD OF THE INVENTION

The invention disclosed herein relates generally to notarial services, and more particularly to a device that can provide proof of execution and acknowledgements of instruments.

### BACKGROUND OF THE INVENTION

A notary is a public official who has the power to administer oaths, take acknowledgements, and perform other duties as permitted by law. Of those duties, an acknowledgement is probably the most common act performed by a notary. An acknowledgement is a formal declaration before an authorized official by a person executing an instrument that such execution is his/her free act and deed. One such instrument that is generally acknowledged is a conveyance of land, but virtually any document that is signed can be acknowledged. A typical acknowledgement form states that the signer of the instrument personally appeared before the notary and acknowledged having signed the instrument for its stated purpose. Thus, for an acknowledgement to be properly taken, the signer of an instrument must personally appear before the notary, acknowledge that he/she signed the instrument in question, and state that it is his/her free act and deed. Acknowledgements for individuals require the notary to either personally know the signer or have the identity of the signer satisfactorily proven on the basis of documents, i.e., acceptable forms of identification. In some jurisdictions, to prove identity the signer must provide the notary with at least two forms of identification containing the signer's signature, at least one of which must also contain the photograph of the signer or a physical description. Upon successful proof of identity and taking of the acknowledgement, including execution of the instrument, the notary will then also sign the instrument and place an embossed seal or stamp indicating the notary's name on the instrument. A completed acknowledgement form clearly indicates what notarial act has been performed, and provides information concerning the execution of the document to anyone who views the document at a later date.

The process for “notarizing” a document as described above is cumbersome and prone to both error and fraud. Verification of a notarized document requires authenticating both the notary's signature and stamp/seal. In many situations, verification occurs many years after the document was notarized. Notary stamps can be easily forged, and signatures often change over time, making such verification difficult at best. Since the verification is a manual (forensic) process, it is prone to errors and can, with relatively minimal effort, be defrauded. In addition, notaries do not keep records of the documents they notarize, and changes to the document can be made by determined attackers. In some countries, notaries are also asked to certify that a copy of a document is identical to an original document. This often involves a visual comparison of the two documents by the notary, which is both time consuming and prone to error.

### SUMMARY OF THE INVENTION

The present invention alleviates the shortcomings of existing notarization practices by providing an automated notarization process. Such automation provides signed data records that can easily be verified and authenticated, removing human judgment from the process. Additionally, any changes to a notarized document can easily be detected.

According to the present invention, a device for performing automated notarization includes a scanner, printer, hardware security module and camera. The hardware security module includes a secure processor and secure storage for data records and cryptographic keys, along with a secure real time clock. A person desiring to have a document notarized can use the scanner to scan the document, presents identification to the device, and has his/her picture and or video taken. Each of these items is stored in a data record, which is then displayed to the person for approval. Upon approval, the data record is provided to the hardware security module, which adds a timestamp to the data record and then digitally signs the data record. The resulting signed data record may be stored in electronic form or printed on a physical document in the form of images and barcodes. The resulting signed data record ties together the original document, and identification of the person, a biometric of the person, e.g., a picture, and a timestamp. Changes to any of these data elements can be detected by verifying the digital signature.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like of corresponding parts.

FIG. 1 illustrates in block diagram form an automated notarization device according to an embodiment of the present invention; and

FIGS. 2A and 2B illustrate in flow diagram form the processing performed by the device according to an embodiment of the present invention.

### DETAILED DESCRIPTION OF THE PRESENT INVENTION

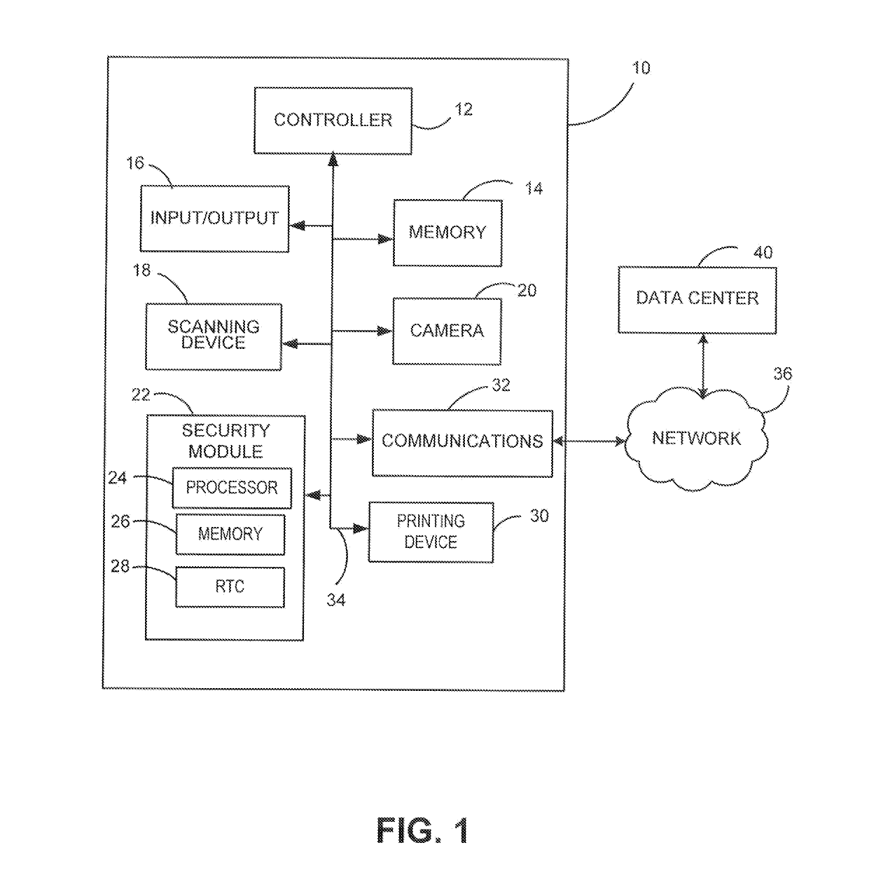

In describing the present invention, reference is made to the drawings, wherein there is seen in FIG. 1 a block diagram of a device 10 for performing automated notarization of documents according to an embodiment of the present invention. Device 10 is preferably a self-service device, and may be a stand-alone device having functionality limited to notarization services, or may be implemented as part of a system that can perform other functions in addition to the notarization services as described herein. For example, device 10 may be implemented as part of a multifunction printer in an office environment, or as part of a kiosk in a retail or public environment. Device 10 includes a control unit, referred to herein as controller 12, which preferably includes one or more processor units, such as, for example, a microprocessor, general or special purpose processor or the like, to control operation of the device 10. A memory device 14 provides storage for information utilized by the controller 12 as well as programs for execution by the controller 12. An input/output (I/O) device 16, such as, for example a display (which may be a touch screen display), keyboard, speaker, or the like, is provided to provide information to and receive information from a user. A scanning device 18 may be provided to scan and read printed documents, and may be any type of suitable optical scanner as are well known. A camera 20 is included for taking photos or videos, and may be any type of suitable image capturing device as are known. A security module 22 is also provided, that includes a secure processor 24, a secure memory 26, and a secure real time clock (RTC) 28. Security module 22 is preferably a secure device that includes a security boundary to prevent tampering with the components included therein, such as, for example, described in U.S. Pat. No. 7,180,008. Processor 24 is capable of performing cryptographic operations, including generating digital signatures and the like, using cryptographic keys that are stored in the memory 26. A printing device 30, which may be, for example, a digital printing device such as a bubble jet or ink jet printing device, is used to print physical documents as described below. Communication between the various internal components of the device 10 is provided by a communication line 34, which may be, for example, a bus or the like. A communications device 32, e.g., modem, network card, or the like, may be provided to allow the device 10 to communicate with a data center 40 via a network 36, such as the Internet or other network, for various features that can include, for example, software downloads, remote data storage, remote device diagnostics, and the like.

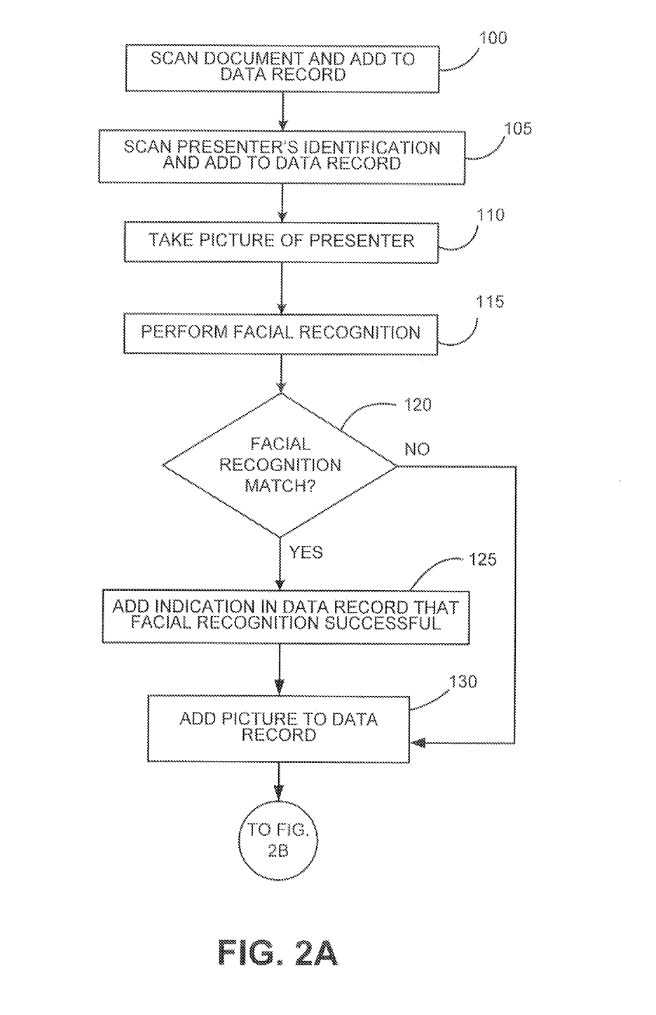

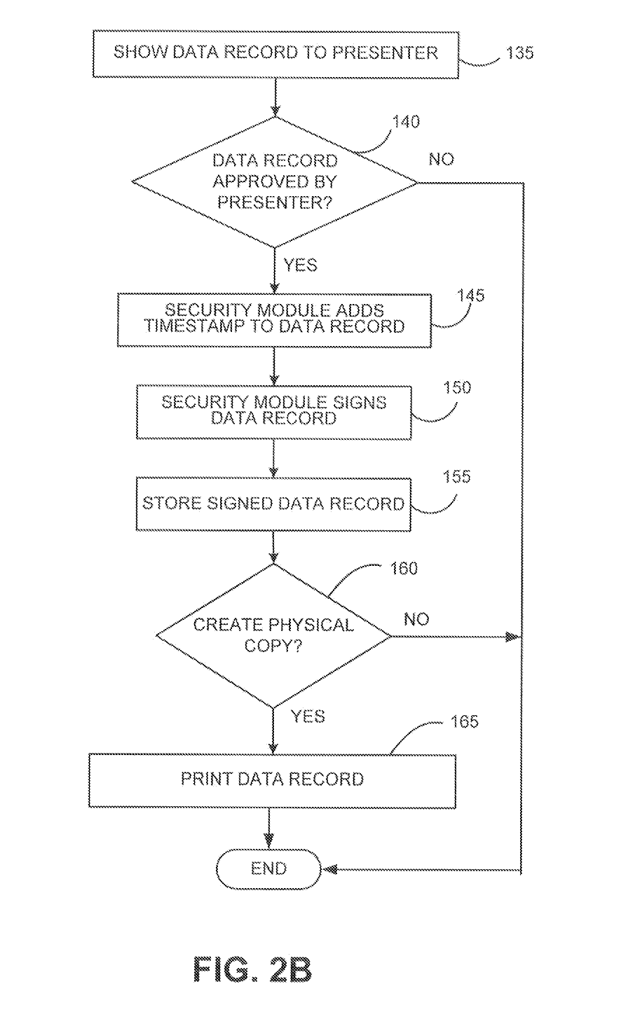

FIGS. 2A and 2B illustrate in flow diagram form the operation of the device 10 to perform an acknowledgment, i.e., a formal declaration by a person executing a document that such execution is his/her free act and deed, in accordance with the principles of the present invention. In step 100, a person desiring to have a document notarized, i.e., an acknowledgement of his/her execution of the document, (hereinafter referred to as the presenter) presents the document, executed by the presenter, to the device 10. The device 10 scans the document using the scanning device 18, creates a data record for this particular transaction, and adds the scanned document to the data record. It should be noted that the scanning need not occur by the device 10, and instead the presenter could also provide an electronic document to the system via the network connection 36 or physical interface, such as a USB port, if desired.

In step 105, the presenter then presents identification to the system. This can be accomplished by placing a recognized form of an identification document (e.g., a driver's license, passport, etc.) on the scanning device 18. The device 10 scans the identification and adds the scanned identification to the data record. Alternatively, a different form of identification can be utilized, such as, for example, a biometric characteristic of the presenter. For example, a fingerprint reader or other biometric device provided in the device 10 (not shown in FIG. 1) could capture a biometric of the presenter and include it in the data record or compare it against a biometric from an identification card. In step 110, the device 10, using the camera 20, obtains an image of the presenter. Preferably, the controller 12 would perform an analysis of the image to ensure that it was in fact a real person and not a life-size poster or other image of someone. This could be accomplished by taking several images or a video of the presenter from different angles to construct a 3D image. Once the image is captured, in step 115 the controller 12 may optionally perform a facial recognition process. This might be the case if the device 10 is a special purpose kiosk. However, a multi-function printer may not have this capability. Thus, the steps describing the facial recognition process (steps 115, 120, 125) may not be performed and instead the process may go directly from step 110 to step 130 where the picture is added to the data record. If a facial recognition process is to be performed, the in step 115 the controller 12 compares the picture scanned from the identification that was presented in step 105 with the photo taken with the camera 20 in step 110. In step 120 it is determined by the controller if a match can be confirmed. If a match of the identification with the taken photo can be confirmed, then in step 125 an indication that the facial recognition resulted in a successful match is added to the data record. Optionally, facial recognition parameters, e.g., ratio of the distance between the eyes, distance from the nose to the mouth, etc., could also be added to the data record. Then in step 130, the picture can optionally be added to the data record, or since a facial recognition match occurred, the photo need not be stored since the identification already includes a picture of the presenter. This can reduce the size of the data record since the taken picture need not be stored. It should be noted that if a match cannot be confirmed it does not necessarily indicate that the presented identification does not belong to the presenter. It may simply be the inability of the matching algorithm to resolve differences in lighting, resolution, etc. Thus, if in step 120 it is determined that there is no facial recognition match, then in step 130 the taken picture is added to the data record.

Referring now to FIG. 2B, in step 135 the contents of the data record is then shown to the presenter, using, for example, a display of the input/output 16 of device 10, and in step 140 the presenter is asked to accept/approve the data record by acknowledging that he/she signed the instrument in question, and stating that it is his/her free act and deed. If in step 140 the presenter does not approve the record, then the device 10 will end the processing. Optionally, the device 10 can provide an opportunity to re-submit or modify parts of the record. If in step 140 the presenter approves the data record, then in step 145 the data record is provided to the hardware security module 22, which adds a timestamp to the data record from the secure real-time clock 28. In step 150, the processor 24 of the security module 22 digitally signs the data record by creating a digital signature for the data record and appending the digital signature to the data record. In step 155, the resulting data record and appended digital signature, also referred to as the signed data record, may be stored in electronic form, e.g., in a database, on a USB drive, on a smart card, etc. In step 160, the presenter can be asked if a physical copy of the signed data record is desired. If not, then the process will end. If a physical copy of the signed data record is requested, then in step 165 the data record can be printed, using the printing device 30, on a medium such as a physical document in the form of images and barcodes. The physical document could be the document that was notarized or other physical document. It is desirable that the entire signed data record be printed as a 2D barcode to ensure that it can be reconstructed without error for verification, since any changes to the record would cause verification to fail. The resulting signed data record created by the device 10 ties together the original document, an identification of the user, a biometric of the user (their picture) and a secure time (from the RTC 28). Any changes to any of these records can be detected by verifying the digital signature.

To authenticate or verify a document that has been notarized by the device 10, the signed data record must first be reconstructed. If the signed data record is electronic it may simply be read from the electronic media. If it is printed the printed document will need to be scanned and the data record reconstructed (e.g., by reading one or more 2D barcodes and assembling them into the signed data record). Once the signed data record is reconstructed the digital signature can be verified using standard digital signature verification techniques. If the signature verifies the various elements of the data record (document, picture, identification card, etc.) are presented to the person wishing to verify the notarization. The person verifying the notarization can then compare the original document with the one in the data record to ensure that the original document was not modified after notarization. Alternatively the person verifying can simply use the document obtained from the data record. The person verifying must also establish the identity of the original presenter. This can be accomplished by comparing the picture in the data record with the identification card in the data record. Alternatively the picture and the identification card (e.g., a picture on the identification card) may be compared using software. If a facial recognition is present in the data record the person verifying may rely upon that indication.

In some embodiments the device 10 can be equipped with a payment device, such as, for example, a credit/debit card reader or cash acceptor to allow the device 10 to accept payment for performing the notarization service. Alternatively, the security module 22 can store prepayment for notarizations in internal registers and debit those registers each time a document is notarized. This might be useful for providing a notarization service to a business, where the business could prepay for a certain number of notarizations. In other embodiments, the security module 22 could restrict the dates and times when notarization can occur. For example, if the device 10 is a kiosk is in a public place the module 22 could refuse to sign/notarize documents during hours when few people are present. This could prevent someone from being coerced to present a document by another person with a gun out of view of the camera in the middle of the night.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a device to perform an acknowledgement of execution of a document by a presenter of the document, the method comprising:
receiving, by the device, a document that has been executed by the presenter and storing the received document in a data record;
receiving, by the device, an identification provided by the presenter and storing the received identification in the data record;
obtaining, using a camera, an image of the presenter and storing the obtained image in the data record;
presenting, using a display device, the data record to the presenter and requesting approval of the data record by the presenter;
adding a timestamp, from a real time clock, to the data record in response to receiving approval of the data record by the presenter; and
creating, by a security module, a digital signature for the data record and appending the digital signature to the data record.

2. The method of claim 1, further comprising:
storing the data record and appended digital signature.

3. The method of claim 1, further comprising:
printing, using a printing device, the data record and digital signature.

4. The method of claim 3, wherein the data record and digital signature are printed in the form of at least one barcode.

5. The method of claim 1, wherein the identification provided by the presenter is an identification document and the method further comprises:
scanning the identification document using a scanning device.

6. The method of claim 1, wherein the identification provided by the presenter is a biometric characteristic of the presenter.

7. The method of claim 1, wherein receiving a document further comprises:
scanning, using a scanning device, the document that has been executed by the presenter.

8. The method of claim 1, further comprising:
performing, by a processing device, a facial recognition process to compare a picture of the presenter from the identification with the obtained image of the presenter.

9. The method of claim 8, further comprising:
adding an indication of a successful match to the data record if the facial recognition process determines that the picture of the presenter from the identification matches the obtained image of the presenter.

10. The method of claim 9, further comprising:
adding at least one facial recognition parameter to the data record.

11. The method of claim 1, further comprising:
accepting, by the device, payment for performing the acknowledgement.

12. The method of claim 1, further comprising:
debiting an internal register of the device for performing the acknowledgement.

13. The method of claim 1, wherein receiving an identification provided by the presenter further comprises:
scanning, using a scanning device, an identification provided by the user.

14. A device for performing an acknowledgement of execution of a document by a presenter of the document, the device comprising:
a processing device;
a scanning device to scan a document that has been executed by the presenter and an identification provided by the presenter;
a camera to obtain an image of the presenter;
a display device; and
a security module that includes a real time clock and a secure processor,
wherein the processing device is programmed to create a data record that includes the scanned document, the scanned identification provided by the presenter, and the obtained image of the presenter, display the data record to the presenter using the display device and request approval of the data record from the presenter, and in response to receiving approval of the data record by the presenter, sending the data record to the security module, and further wherein the security module adds a timestamp from the real time clock to the data record and the secure processor creates a digital signature for the data record and append the digital signature to the data record.

15. The device of claim 14, further comprising:
a memory for storing the data record and appended digital signature.

16. The device of claim 14, further comprising:
a printer for printing the data record and digital signature.

17. The device of claim 16, wherein the data record and digital signature are printed in the form of an image and at least one barcode.

18. The device of claim 14, wherein the processing device is further programmed to perform a facial recognition process to compare a picture of the presenter from the identification with the obtained image of the presenter.

19. The device of claim 18, wherein the processing device is further programmed to add an indication of a successful match to the data record if the facial recognition process determines that the picture of the presenter from the identification matches the obtained image of the presenter.
